(19) United States
(12) Patent Application Publication
(10) Pub. No.: US 2024/0248743 A1
(43) Pub. Date: Jul. 25, 2024

(54) SERVICE GATEWAY FOR SCALING OF VIRTUAL DESKTOP DEPLOYMENTS

(71) Applicant: VMware, Inc., Palo Alto, CA (US)

(72) Inventors: Mahadevan Vishwanth IYER, Saratoga, CA (US); Julio Cesar FERNANDES CORREA, Gilroy, CA (US); Kushal BHANDARI, Newark, CA (US); Nan WANG, San Jose, CA (US); Dinesh M SHANMUGAM, San Jose, CA (US)

(21) Appl. No.: 18/157,802

(22) Filed: Jan. 20, 2023

(51) Int. Cl. G06F 9/455; G06F 9/451

(52) U.S. Cl. CPC G06F 9/45558; G06F 9/452; G06F 2009/4557; G06F 2009/45587; G06F 2009/45595

(57) ABSTRACT

An example method of provisioning a virtual desktop deployment includes: receiving, at an admin service executing on first virtualized infrastructure, deployment information for the virtual desktop deployment, the deployment information including a capacity and an image; providing the deployment information from the admin service to a lifecycle manager (LCM) executing on second virtualized infrastructure; provisioning, by the LCM in cooperation with a provider of a third virtualized infrastructure, virtual machines (VMs) based on the capacity and the image; providing, by the LCM to a first VM of the VMs, connection information for a message cluster in a fourth virtualized infrastructure; and connecting, by a virtual desktop (VD) agent executing in the first VM, to the message cluster based on the connection information.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers. SDDC users move through various business cycles, requiring them to expand and contract SDDC resources to meet business needs. This leads users to employ multi-cloud solutions, such as typical hybrid cloud solutions where the SDDC spans across an on-premises data center and a public cloud.

For ease of deployment, software management, and hardware cost reduction reasons, virtual machines (VMs) executing in an SDDC have been used to support virtual desktops for use in an organization in place of physical workstations. Service clients (e.g., users operating remote devices) access virtual desktops executing in VMs through a service gateway. In a multi-cloud system, for example, it is desirable to deploy the service gateway to enable efficient scaling of virtual desktops across many geographically dispersed users.

### SUMMARY

In embodiments, a method of provisioning a virtual desktop deployment includes: receiving, at an admin service executing on first virtualized infrastructure, deployment information for the virtual desktop deployment, the deployment information including a capacity and an image; providing the deployment information from the admin service to a lifecycle manager (LCM) executing on second virtualized infrastructure; provisioning, by the LCM in cooperation with a provider of a third virtualized infrastructure, virtual machines (VMs) based on the capacity and the image; providing, by the LCM to a first VM of the VMs, connection information for a message cluster in a fourth virtualized infrastructure; and connecting, by a virtual desktop (VD) agent executing in the first VM, to the message cluster based on the connection information.

In embodiments, a method of establishing a connection between a service client and a virtual desktop includes: receiving, at a service portal executing in a first virtualized infrastructure, selection of a virtual desktop of the service client; receiving, at the service portal from an inventory manager executing in a second virtualized infrastructure, a virtual machine (VM) specification based on the virtual desktop; providing the VM specification from the service portal to a connection service executing in a third virtualized infrastructure; preparing, by the connection service based on the VM specification, a VM executing in a fourth virtualized infrastructure to accept a connection from the service client; and connecting, by the service client through an internet gateway executing in the fourth virtualized infrastructure, to the VM to access the virtual desktop.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1A is a block diagram depicting a multi-cloud system in which embodiments may be implemented.

FIG. 1B is a block diagram depicting virtual desktop deployment according to embodiments.

FIG. 2 is a block diagram of a virtualized computing system in which embodiments may be implemented.

FIG. 3 is a block diagram depicting a configuration of virtual desktop deployment according to embodiments.

FIG. 4 is a block diagram depicting a service gateway according to embodiments.

FIG. 5 is a flow diagram depicting a method of provisioning a virtual desktop deployment according to embodiments.

FIG. 6 is a block diagram depicting a service gateway according to embodiments.

FIG. 7 is a flow diagram depicting a method of connecting to a virtual desktop according to embodiments.

### DETAILED DESCRIPTION

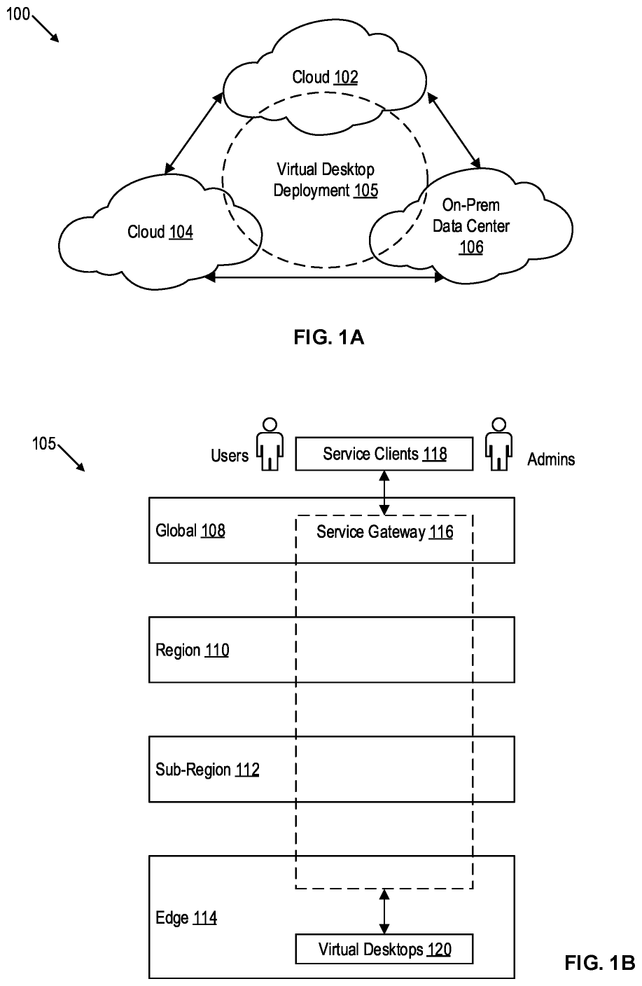

FIG. 1A is a block diagram depicting a multi-cloud system 100 in which embodiments may be implemented. Multi-cloud system 100 includes clouds 102 and 104 and an on-premises (on-prem) data center 106. On-prem data center 106 can be a private data center or cloud managed by an organization. Although only a single on-prem data center 106 is shown, multi-cloud system 100 can include multiple on-prem data centers 106. Clouds 102 and 104 can be public clouds where the organization is a customer thereof. Although only two clouds 102, 104 are shown, multi-cloud system 100 can include one or more clouds operating as public clouds. In embodiments, multi-cloud system 100 can include only public clouds, only on-prem data centers, or a combination thereof as shown in the example (sometimes referred to as a hybrid cloud). As described below, multi-cloud system 100 can host a virtual desktop deployment 105. Virtual desktop deployment 105 includes virtual desktops executing in virtual computing instances, such as virtual machines (VMs), and a service gateway configured to provide access to the virtual desktops on behalf of users operating service clients. A virtual desktop is a preconfigured image of an operating system (OS) and applications in which the desktop environment (executing in the VM) is separated from the physical device used to access the desktop environment (the service clients). Users access virtual desktops over a network, such as the public Internet or a corporate network. Service clients include, for example, desktop computers, laptop computers, mobile devices, tablets, and the like.

FIG. 1B is a block diagram depicting virtual desktop deployment 105 according to embodiments. Virtual desktop deployment 105 includes a service gateway 116 and virtual desktops 120. Users of service clients 118 access virtual desktops 120 through service gateway 116. Administrators (admins) can configure service gateway 116 and virtual desktops 120 through service gateway 116. Components of service gateway 116 are deployed across different virtualized infrastructure, including a global virtualized infrastructure (global 108), a regional virtualized infrastructure (region 110), a sub-regional virtualized infrastructure (sub region 112), and an edge virtualized infrastructure (edge 114). Global 108 can service a largest area (e.g., multiple continents). Region 110 can service a large area, such as one or more continents (e.g., North America, Europe, South America, Asia, etc.). Sub-region 112 can service a portion of a region (e.g., NA-West, NA-East, EU-Central, etc.). Edge 114 includes the VMs in which virtual desktops 120 execute. Global 108 can service one or more regions 110; region 110 can service one or more sub-regions; and sub-region 112 can service one or more edges 114. Admins can configure service gateway 116 to connect users to virtual desktops executing in geographically nearest edges 114 to provide for best performance and user experience.

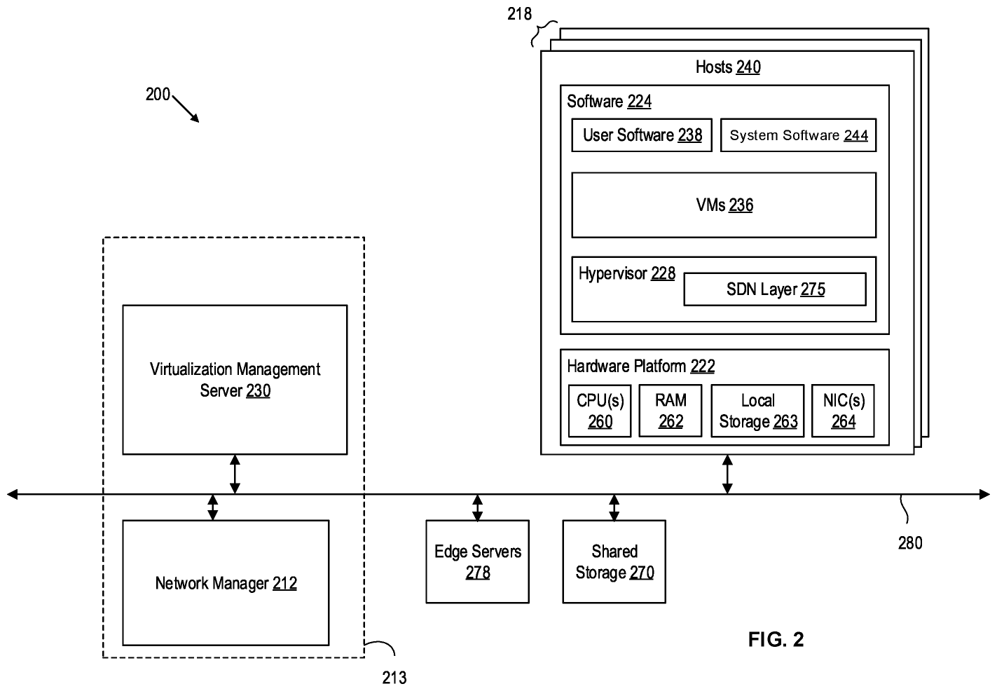

FIG. 2 is a block diagram of a virtualized computing system 200 in which embodiments may be implemented. Virtualized computing system 200 can be part of a cloud or on-prem data center of multi-cloud system 100. Virtualized computing system 200 includes a cluster of hosts 240 (“host cluster 218”) that may be constructed on hardware platforms such as an x86 architecture platforms. For purposes of clarity, only one host cluster 218 is shown. However, virtualized computing system 200 can include many of such host clusters 218. As shown, a hardware platform 222 of each host 240 includes conventional components of a computing device, such as one or more central processing units (CPUs) 260, system memory (RAM) 262, one or more network interface controllers (NICs) 264, and optionally local storage 263. CPUs 260 are configured to execute instructions, for example, executable instructions that perform one or more operations described herein, which may be stored in RAM 262. NICs 264 (also referred to as physical NICs or pNICs) enable host 240 to communicate with other devices through a physical network 280. Physical network 280 enables communication between hosts 240 and between other components and hosts 240 (other components discussed further herein).

In FIG. 2, hosts 240 may access shared storage 270 by using NICs 264 to connect to network 280. In another embodiment, each host 240 contains a host bus adapter (HBA) through which input/output operations (IOs) are sent to shared storage 270 over a separate network. Shared storage 270 include one or more storage arrays, such as a storage area network (SAN), network attached storage (NAS), or the like. Hosts 240 may include local storage 263 (e.g., hard disk drives, solid-state drives, etc.). Local storage 263 in each host 240 can be aggregated and provisioned as part of a virtual SAN, which is another form of shared storage 270.

Software 224 of each host 240 provides a virtualization laver, referred to herein as a hypervisor 228, which abstracts processor, memory, storage, and network resources of hardware platform 222 to provide a virtual machine execution space within which multiple virtual machines (VMs) 236 may be concurrently instantiated and executed. VMs 236 provide isolated execution spaces on a single physical host within which separate operating systems and application software can execute. In an embodiment, there is no intervening software, such as a host operating system (OS), between hypervisor 228 and hardware platform 222. Thus, hypervisor 228 can be a Type-1 hypervisor (also known as a “bare-metal” hypervisor). As a result, the virtualization layer in host cluster 218 (collectively hypervisors 228) can be a bare-metal virtualization layer executing directly on host hardware platforms. VMs 236 can execute software deployed by users (e.g., user software 242), as well as system software 244 deployed by management/control planes to provide support. System software 244 can execute in VMs 236 transparent to the user (e.g., the user interacts with the management/control planes and the management/control planes deploy VMs 236 with system software 244 transparently to the user) User software 242 can include virtual desktops, agents, service gateway components, and the like of virtual desktop deployment 105.

Host cluster 218 is configured with a software-defined network (SDN) layer 275 at least partially implemented by hypervisors 228. SDN layer 275 includes logical network services executing on virtualized infrastructure in host cluster 218. The virtualized infrastructure that supports the logical network services includes hypervisor-based components, such as resource pools, virtual switches, etc., as well as VM-based components, such as router control VMs, load balancer VMs, edge servers, etc. Logical network services include logical switches and logical routers, as well as logical firewalls, logical load balancers, and the like, implemented on top of the virtualized infrastructure. Virtualized computing system 200 may include edge servers 278 that provide an interface of host cluster 218 to a wide area network (WAN) (e.g., a corporate network, the public Internet, etc.). Edge servers 278 can be physical servers or VMs.

Virtualization management server 230 is a physical or virtual server that manages host cluster 218 and the virtualization layer therein. Virtualization management server 230 installs agent(s) in hypervisor 228 to add a host 240 as a managed entity. Virtualization management server 230 logically groups hosts 240 into host cluster 218 to provide cluster-level functions to hosts 240. The number of hosts 240 in host cluster 218 may be one or many. Virtualization management server 230 can manage more than one host cluster 218.

In an embodiment, virtualized computing system 200 further includes a network manager 212. Network manager 212 is a physical or virtual server that orchestrates SDN layer 275. In an embodiment, network manager 212 comprises one or more virtual servers deployed as VMs. Network manager 212 installs additional agents in hypervisor 228 to add a host 240 as a managed entity, referred to as a transport node. In this manner, host cluster 218 can be a cluster of transport nodes. Network manager 112 and virtualization management server 130 can execute in a management cluster 213.

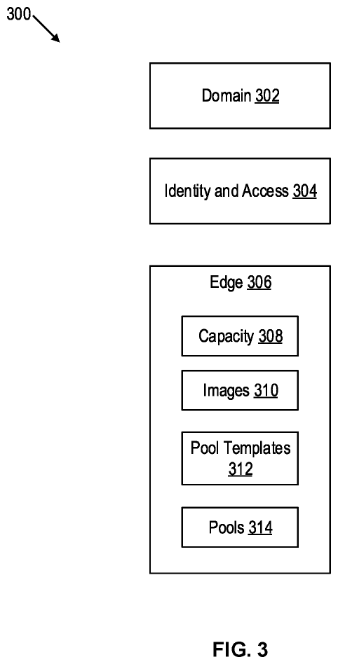

FIG. 3 is a block diagram depicting a configuration 300 of virtual desktop deployment 105 according to embodiments. An admin can interact with service gateway 116 to establish configuration 300. Configuration 300 includes domain 302, identity and access 304, and edge 306 configurations. Domain 302 can be an Active Directory domain, lightweight directory access protocol (LDAP) domain, or the like registered for the virtual desktop deployment. Identity and access 304 connects the virtual desktop deployment to an identity provider for user authentication and access to virtual desktop deployment. Edge 306 includes configurations for capacity 308, images 310, pool templates 312, and pools 314. An admin configures capacity 308 to provide compute, network, storage, etc. resources supporting a number of virtual desktops for a set of users. This allows for deployment of a certain number of VMs to execute the virtual desktops. For capacity 308, the admin can specify one or more images 310 to be used for the virtual desktops. An image 310 includes an OS, applications, and customizations (e.g., specific settings, configurations, etc.) that can be installed and executed in a VM to render a virtual desktop. A pool template 312 is a group of VMs (or physical machines) (e.g., some portion of capacity 308) that have the same image 310 and are managed as a single entity. The admin can create pools 314. Each pool 314 can include one or more pool templates 312. Each pool 314 allows for entitlement of desktops and applications to any users or groups of users in domain 302 (e.g., one pool 314 for a human resources department, another pool for an engineering department, etc.).

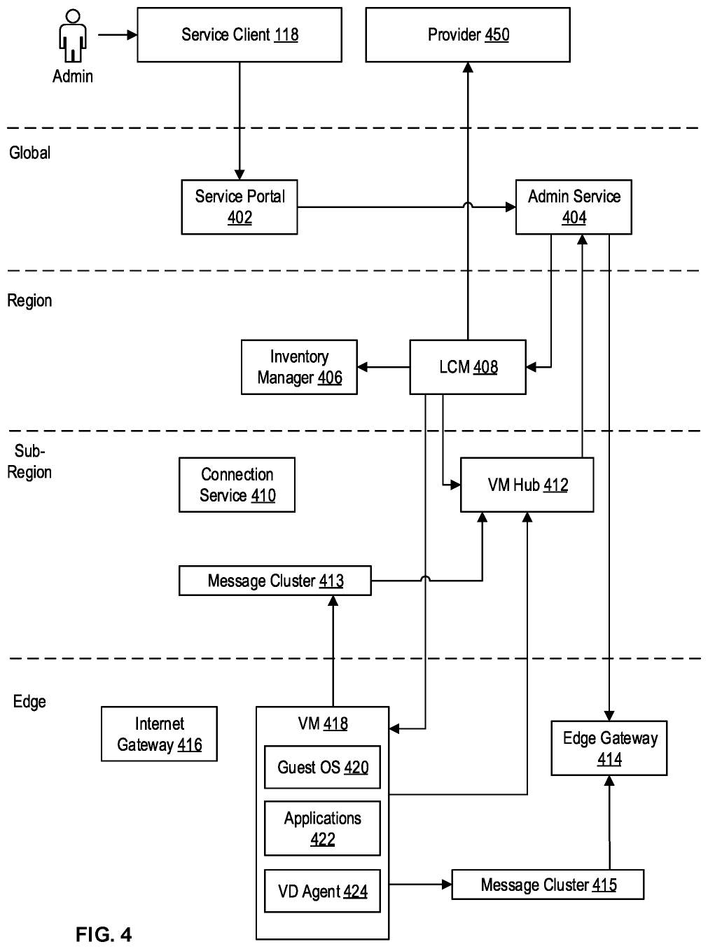

FIG. 4 is a block diagram depicting service gateway 116 according to embodiments. Service gateway 116 includes components distributed across global, region, sub-region, and edge locations. Service gateway 116 includes a service portal 402 and an admin service 404 in global 108. Service portal 402 and admin service 404 can communicate with components of service gateway 116 in all regions 110, sub-regions 112, and edges 114. In each region 110, service gateway 116 includes an inventory manager 406 and a lifecycle manager (LCM) 408. In each sub-region 112 of a region 110, service gateway 116 includes a connection service 410, a VM hub 412, and a message cluster 413. In each edge 114, service gateway 116 includes an internet gateway 416, an edge gateway 414, a message cluster 415, and a plurality of VMs 418 (for purposes of clarity by example, only a single VM 418 is shown). Each VM 418 includes a guest OS 420, applications 422, and a virtual desktop (VD) agent 424.

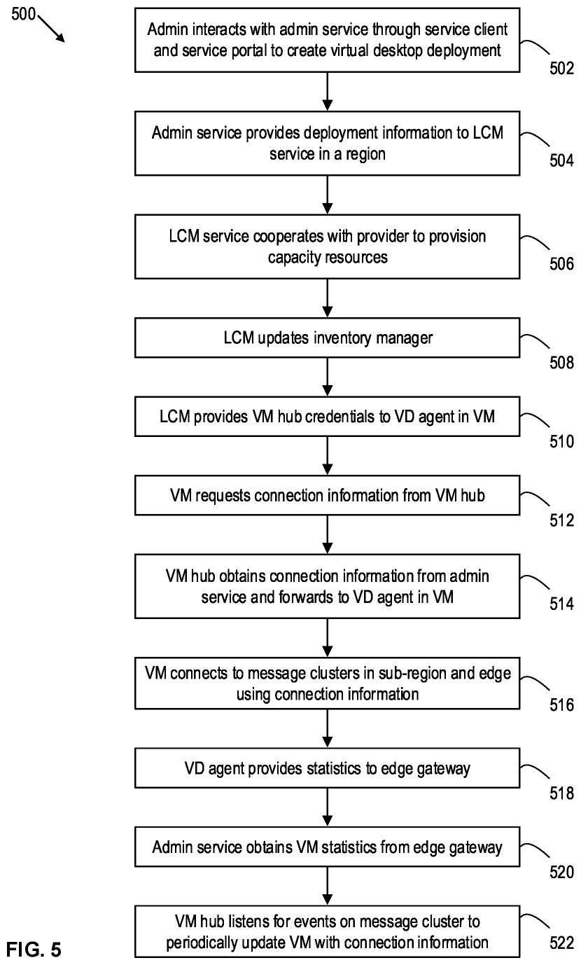

FIG. 4 shows connections between components that occur during provisioning of a virtual desktop deployment. FIG. 5 is a flow diagram depicting a method 500 of provisioning a virtual desktop deployment according to embodiments. Method 500 can be understood with respect to service gateway 116 as shown in FIG. 4.

Referring to FIGS. 4-5, method 500 begins at step 502, where an admin interacts with admin service 404 through service client 118 and service portal 402. The admin can authenticate to service portal 402, which connects to admin service 404. The admin can create a virtual desktop deployment for a region 110 as shown in FIG. 3, including defining capacity 308, images 310, pool templates 312, and pools 314. At step 504, admins service 404 provides deployment information to LCM 408 in region 110. The deployment information can include information related to capacity 308, images 310, pool templates 312, and pools 314 as specified by the admin.

At step 506, LCM 408 cooperates with a provider 450 to provision the resources based on capacity 308 and images 310 (e.g., VMs having specified CPU, memory, storage, network, etc. resources and configured with images 310). Provider 450 is any management plane interface of a respective cloud or on-prem data center in which edge 114 is deployed. Provider 450 deploys VMs 418 in response to request from LCM 408. At step 508, LCM 408 updates inventory manager 406 with the provisioned capacity (VMs 418 in edge 114). Inventory manager 406 tracks provisioned capacity across multiple edges 114 and sub-regions 112.

At step 510, LCM 408 requests one-time access credentials from VM hub 412 and provides such credentials to VD agent 424 in VM 418. At step 512, VD agent 424 accesses VM hub 412 with the one-time access credentials and requests connection information for sub-region 412. The connection information allows VM 418 to register with sub-region 412 to virtual desktop connection requests from users. In embodiments, the connection information includes endpoint information and credentials for connecting to the endpoint. As shown in FIG. 4, the endpoint in sub-region 112 is message cluster 413. Message cluster 413 is configured to receive messages and disperse events based on the messages to services subscribed to such events. In embodiments, message cluster 413 is an MQTT cluster, although other types of message clusters can be used. The connection information can also be used to access message cluster 415 in edge 114.

At step 514, VM hub 412 obtains connection information for message clusters 413 and 415 from admin service 404 and forwards the connection information to VD agent 424 in VM 418. At step 516, VD agent 424 in VM 418 connects to message clusters 413 and 415 using the connection information. As described further below, VD agent 424 can cooperate with connection service 410 through message cluster 413 during virtual desktop connection requests by users.

At step 518, VD agent 424 can provide statistics to edge gateway 414 through message cluster 415. Such statistics can include CPU, memory, storage, network, etc. statistics and the like. At step 520, admin service 404 can obtain VM statistics from edge gateway 414. The admin can view VM statistics on service client 118 as presented by admin service 404.

In embodiments, the connection information for connecting VM 418 to message clusters 413 and 415 can expire periodically. VM hub 412 can subscribe to events from message cluster 413 to detect when the connection information used by VM 418 as expired. VM hub 412 can then initiate a refresh of the connection credentials for VM 418.

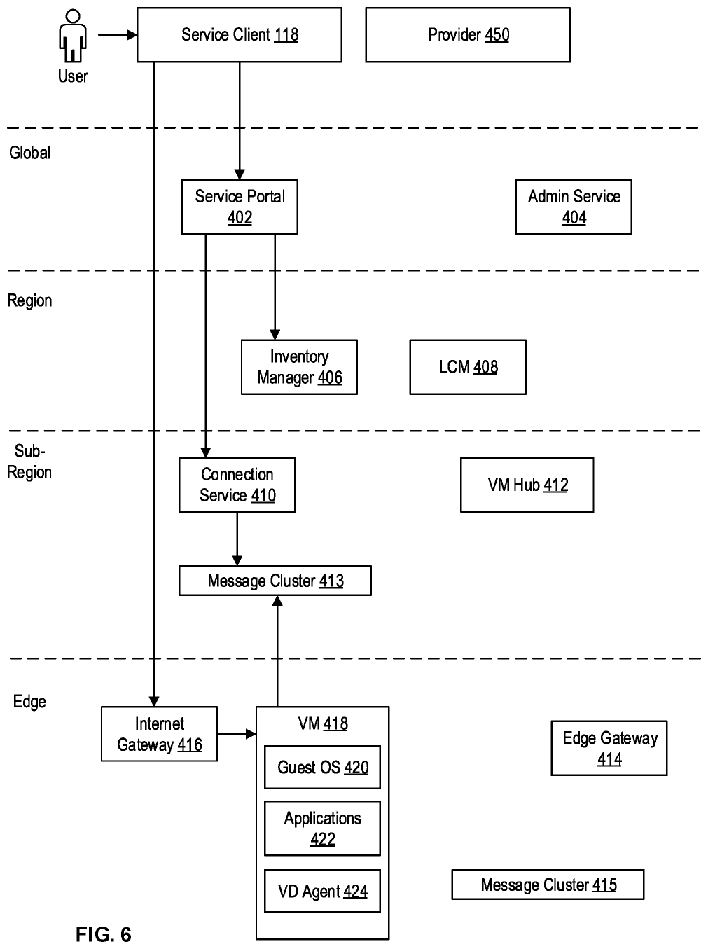

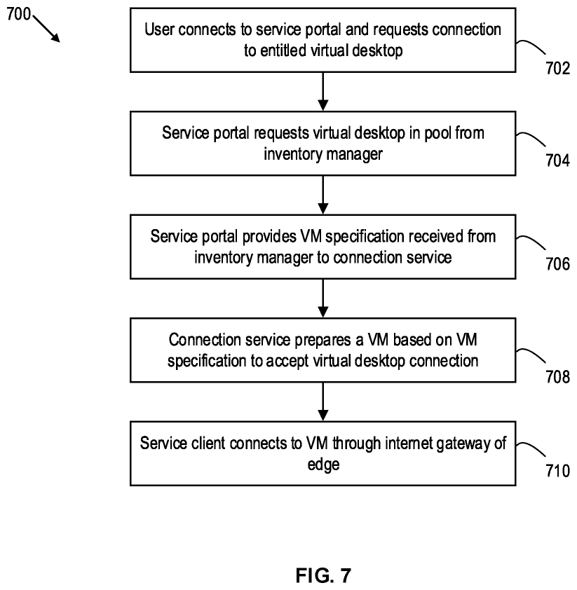

FIG. 6 is a block diagram depicting service gateway 116 according to embodiments. Elements in FIG. 6 that are the same or similar to those of FIG. 4 are designated with identical reference numerals. FIG. 6 shows connections between components that occur during user connection to a virtual desktop. FIG. 7 is a flow diagram depicting a method 700 of connecting to a virtual desktop according to embodiments. Method 700 can be understood with respect to service gateway 116 as shown in FIG. 6.

Referring to FIGS. 6-7, method 700 begins at step 702, where a user connects to service portal 402 and requests connection to an entitled virtual desktop. As described above, a virtual desktop deployment can include pools of virtual desktops and a user or group of users can be associated with one or more pools. Service portal 402 can display entitled pools and virtual desktops to the user and the user can select a virtual desktop to launch. At step 704, service portal 402 requests an entitled virtual desktop as selected from the user from inventory manager 406 of region 110. Inventory manager 406 matches the virtual desktop as requested with a VM executing the virtual desktop and returns an VM specification to service portal 402.

At step 706, service portal 402 provides the VM specification to connection service 410 in sub-region 112. At step 708, connection service 410 prepares VM 418 based on VM specification to accept a virtual desktop connection from service client 118. Connection service 410 communicates with VM 418 through message cluster 413. At step 710, service client 118 connects to VM 418 through internet gateway 416 of edge 114. VM 418 renders the virtual desktop and sends image data to service client 118 through internet gateway 416 to display the virtual desktop.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of provisioning a virtual desktop deployment, comprising:
receiving, at an admin service executing on first virtualized infrastructure, deployment information for the virtual desktop deployment, the deployment information including a capacity and an image;
providing the deployment information from the admin service to a lifecycle manager (LCM) executing on second virtualized infrastructure;
provisioning, by the LCM in cooperation with a provider of a third virtualized infrastructure, virtual machines (VMs) based on the capacity and the image;
providing, by the LCM to a first VM of the VMs, connection information for a message cluster in a fourth virtualized infrastructure; and
connecting, by a virtual desktop (VD) agent executing in the first VM, to the message cluster based on the connection information.

2. The method of claim 1, further comprising:
updating, by the LCM, an inventory manager executing in the second virtualized infrastructure with the VMs as provisioned.

3. The method of claim 1, wherein the step of providing the connection information comprises:
obtaining, by the LCM, credentials from a VM hub executing in the fourth virtualized infrastructure;
providing the credentials from the LCM to the VD agent in the first VM;
connecting by the VD agent to the VM hub to obtain the connection information.

4. The method of claim 3, wherein the VM hub obtains the connection information from the admin service.

5. The method of claim 1, further comprising:
connecting, by the VD agent, to another message cluster executing in the third virtualized infrastructure; and
sending statistics associated with the first VM from the VD agent to an edge gateway executing in the third virtualized infrastructure through the other message cluster.

6. The method of claim 5, wherein the admin service connects to the edge gateway to obtain the statistics.

7. The method of claim 1, wherein the first VM communicates with a connection service in the fourth virtualized infrastructure through the message cluster to establish a virtual desktop connection with a user.

8. A method of establishing a connection between a service client and a virtual desktop, comprising:
receiving, at a service portal executing in a first virtualized infrastructure, selection of a virtual desktop of the service client;
receiving, at the service portal from an inventory manager executing in a second virtualized infrastructure, a virtual machine (VM) specification based on the virtual desktop;
providing the VM specification from the service portal to a connection service executing in a third virtualized infrastructure;
preparing, by the connection service based on the VM specification, a VM executing in a fourth virtualized infrastructure to accept a connection from the service client; and
connecting, by the service client through an internet gateway executing in the fourth virtualized infrastructure, to the VM to access the virtual desktop.

9. The method of claim 8, wherein the connection service and the VM are connected through a message cluster executing in the third virtualized infrastructure.

10. The method of claim 8, wherein the VM receives connection information for connecting to the message cluster from a VM hub executing in the third virtualized infrastructure.

11. A computing system, comprising:
a first virtualized infrastructure having an admin service executing to receive deployment information for a virtual desktop deployment, the deployment information including a capacity and an image;
a second virtualized infrastructure having a lifecycle manager (LCM) configured to receive the deployment information from the admin service and to provision, in cooperation with a providing of a third virtualized infrastructure, virtual machines (VMs) based on the capacity and the image;
the third virtualized infrastructure including a first VM of the VMs having a virtual desktop (VD) agent executing therein; and
a fourth virtualized infrastructure executing a message cluster, the LCM providing connection information to the VD agent and the VD agent connecting to the message cluster using the connection information.

12. The computing system of claim 11, wherein the second virtualized infrastructure executes an inventory manager, and wherein the LCM is configured to update the inventory manager with the VMs as provisioned.

13. The computing system of claim 11, wherein the LCM provides the connection information by obtaining credentials from a VM hub executing in the fourth virtualized infrastructure, providing the credentials from the LCM to the VD agent in the first VM, and connecting by the VD agent to the VM hub to obtain the connection information.

14. The computing system of claim 13, wherein the VM hub obtains the connection information from the admin service.

15. The computing system of claim 11, wherein the third virtualized infrastructure includes another message cluster, and wherein the VD agent is configured to connect to the other message cluster to send statistics associated with the first VM from the VD agent to an edge gateway executing in the third virtualized infrastructure.

16. The computing system of claim 15, wherein the admin service connects to the edge gateway to obtain the statistics.

17. The computing system of claim 11, wherein the first VM communicates with a connection service in the fourth virtualized infrastructure through the message cluster to establish a virtual desktop connection with a user.

18. A non-transitory computer readable medium comprising instructions to be executed in a computing device to cause the computing device to carry out a method of provisioning a virtual desktop deployment, comprising:
receiving, at an admin service executing on first virtualized infrastructure, deployment information for the virtual desktop deployment, the deployment information including a capacity and an image;
providing the deployment information from the admin service to a lifecycle manager (LCM) executing on second virtualized infrastructure;
provisioning, by the LCM in cooperation with a provider of a third virtualized infrastructure, virtual machines (VMs) based on the capacity and the image;
providing, by the LCM to a first VM of the VMs, connection information for a message cluster in a fourth virtualized infrastructure; and
connecting, by a virtual desktop (VD) agent executing in the first VM, to the message cluster based on the connection information.

19. The non-transitory computer readable medium of claim 18, wherein the step of providing the connection information comprises:
obtaining, by the LCM, credentials from a VM hub executing in the fourth virtualized infrastructure;
providing the credentials from the LCM to the VD agent in the first VM;
connecting by the VD agent to the VM hub to obtain the connection information.

20. The non-transitory computer readable medium of claim 18, further comprising:
connecting, by the VD agent, to another message cluster executing in the third virtualized infrastructure; and
sending statistics associated with the first VM from the VD agent to an edge gateway executing in the third virtualized infrastructure through the other message cluster.
